(19) United States
(12) Patent Application Publication
(10) Pub. No.: US 2026/0271972 A1
(43) Pub. Date: Sep. 17, 2026

(54) PROCESS FOR A LEGUME BASED DRIED INSTANT NOODLE

(71) Applicant: SOCIÉTÉ DES PRODUITS NESTLÉ S.A., Vevey (CH)

(72) Inventors: Prateeksha GARG, Gurgaon (IN); Neelam GULIA, Gurgaon (IN); Om Prakash SINGH, Patna (IN); Piyush MEHROTRA, Gurgaon (IN)

(21) Appl. No.: 19/166,741

(22) PCT Filed: Mar. 19, 2024
(86) PCT No.: PCT/EP2024/057222

§ 371 Date: Sep. 18, 2025

(30) Foreign Application Priority Data
Mar. 22, 2023 (IN) 202311019878
May 8, 2023 (EP) 23171979.0

(51) Int. Cl. A23L 7/113; A23L 7/10; A23L 7/109; A23L 11/00

(52) U.S. Cl. CPC A23L 7/113; A23L 7/101; A23L 7/111; A23L 11/05

(57) ABSTRACT

The present invention relates to a process for the production of a legume based dried instant noodle. In particularly the invention relates to a process for the production of a legume based dried instant noodle using roasted legume flour selected from the group of chickpea splits, lentil splits, or a combination thereof, and cereal flour and starch and wheat gluten.

The present invention relates to a process for the production of a legume based dried instant noodle. In particularly the invention relates to a process for the production of a legume based dried instant noodle using roasted legume flour selected from the group of chickpea flour, lentil flour, or a combination thereof, and cereal flour and starch and wheat gluten.

It is already known to have a legume-based noodle. The noodles are using legume flour in an amount less of 20 wt %. It is well known that legume flour is a good source of plant-based protein (>20 wt %) but it possesses inherent bitterness, off-notes, chalkiness, and mostly non-gelatinized form of starch granules (closed cell structure). The manufacturing of dried instant noodles with higher inclusion of legume flour (>25%) using lamination technology has been challenging. It shows dough rheological and machinability issues like sticky dough, poor sheeting or sheet breakage, and in the finished noodles issues like strand stickiness, hard texture and rawness/off-flavor.

Therefore, in order to provide nutritional benefits of higher amounts of protein in dried instant noodles it is hence essential to explore a process having good machinability, good rheology of the noodle dough and having a pleasant taste.

### SUMMARY OF THE INVENTION

The object of the present invention is to improve the state of the art and to provide an improved or at least an alternative solution to overcome at least some of the inconveniences described above. The object of the present invention is achieved by the subject matter of the independent claims. The dependent claims further develop the idea of the present invention.

Particularly, the object of the present invention is to provide a process for the production of a legume based dried instant noodle having good machinability and rheology, higher in protein nutritional value and fiber compared to grain based dried instant noodles and still having good sensory attributes like texture, flavor and a shelf life of at least 9 months of the product.

Accordingly, the present invention provides in a first aspect a process for the production of a legume based dried instant noodle comprising legume flour, cereal flour, Kansui salts, starch and wheat gluten, the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Cutting the noodle strands from step d) and optionally folding;
f) Frying the noodle strands from step e) in oil or air drying the noodle strands from step e);
g) Cooling.

In a second aspect the invention relates to a legume based dried instant noodle comprising legume flour, cereal flour, starch, Kansui salts and wheat gluten, wherein the legume based dried instant noodle has an amount of protein of at least 10 wt % (by weight of the total composition); wherein the legume flour is selected from the group of chickpea flour, lentil flour, or a combination thereof, preferably roasted chickpea flour, roasted lentil flour, or combinations thereof.

It has been surprisingly found by the inventors that by using a roasted chickpea flour, roasted lentil flour, or a combination thereof, to substitute cereal flour, starch and wheat gluten existing lamination technology has acceptable to good machinability and good sensory attributes in terms of non-sticky dough, sheeting, texture (not firm, chewy), good flavor profile (no raw and/or bitter off note flavor of the legumes) and the obtained dried instant noodle has optimum water absorption while cooking the noodles.

### DETAILED DESCRIPTION OF THE INVENTION

In a first aspect the present invention pertains to a process for the production of a legume based dried instant noodle comprising legume flour, cereal flour, Kansui salts, starch, oil and wheat gluten, the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Cutting the noodle strands from step d) and optionally folding;
f) Frying the noodle strands from step e) in oil or air drying the noodle strands from step e);
g) Cooling.

In a preferred aspect the present invention pertains to a process for the production of a legume based dried instant noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition) and 1 to 20 wt % of starch (by weight of the total composition), the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Cutting the noodle strands from step d) and optionally folding;
f) Frying the noodle strands from step e) in oil or air drying the noodle strands from step e);
g) Cooling.

In a preferred aspect the present invention pertains to a process for the production of a legume based dried instant noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition) and 1 to 20 wt % of starch (by weight of the total composition), the process comprising the steps of:
a) Roasting legume splits selected from the group of chickpea splits, lentil splits, or a combination thereof;
b) Milling the roasted legume splits to obtain roasted legume flour;
c) Mixing the roasted legume flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Cutting the noodle strands from step e) and optionally folding;
g) Frying the noodle strands from step f) in oil or air drying the noodle strands from step f);
h) Cooling.

In a preferred aspect the present invention pertains to a process for the production of a legume based dried instant noodle comprising 10 to 60 wt % of chickpea flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition) and 1 to 20 wt % of starch (by weight of the total composition), the process comprising the steps of:
a) Roasting chickpea splits;
b) milling the roasted chickpea splits to obtain roasted chickpea flour;
c) Mixing the roasted chickpea flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Cutting the noodle strands from step e) and optionally folding;
g) Frying the noodle strands from step f) in oil or air drying the noodle strands from step f);
h) Cooling.

In a preferred aspect the present invention pertains to a process for the production of a legume based dried instant noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition) and 2 to 15 wt % of starch (by weight of the total composition), the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Cutting the noodle strands from step d) and optionally folding;
f) Frying the noodle strands from step e) in oil or air drying the noodle strands from step e);
g) Cooling.

In a preferred aspect the present invention pertains to a process for the production of a legume based dried instant noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition) and 2 to 15 wt % of starch (by weight of the total composition), the process comprising the steps of:
a) Roasting legume splits selected from the group of chickpea splits, lentil splits, or a combination thereof;
b) Milling the roasted legume splits to obtain roasted legume flour;
c) Mixing the roasted legume flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Cutting the noodle strands from step e) and optionally folding;
g) Frying the noodle strands from step f) in oil or air drying the noodle strands from step f);
h) Cooling.

In a preferred aspect the present invention pertains to a process for the production of a legume based dried instant noodle comprising 27 to 50 wt % of chickpea flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition) and 2 to 15 wt % of starch (by weight of the total composition), the process comprising the steps of:
a) Roasting chickpea splits;
b) Milling the roasted chickpea splits to obtain roasted chickpea flour;
c) Mixing the roasted chickpea flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Cutting the noodle strands from step e) and optionally folding;
g) Frying the noodle strands from step f) in oil or air drying the noodle strands from step f);
h) Cooling.

In a preferred aspect the present invention pertains to a process for the production of a legume based instant fried noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition), 1 to 20 wt % of starch (by weight of the total composition) and 10 to 25 wt % of oil (by weight of the total composition), the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Optionally seasoning;
f) Cutting and folding the noodle strands from steps d) or e);
g) Optionally pre-drying to remove moisture before frying;
h) Frying in the oil;
i) Cooling.

In a preferred aspect the present invention pertains to a process for the production of a legume based instant fried noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition), 1 to 20 wt % of starch (by weight of the total composition) and 10 to 25 wt % of oil (by weight of the total composition), the process comprising the steps of:
a) Roasting legume splits selected from the group of chickpea splits, lentil splits, or a combination thereof;
b) Milling the roasted legume splits to obtain roasted legume flour;
c) Mixing the roasted legume flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Optionally seasoning;
g) Cutting and folding the noodle strands from steps e) or f);
h) Optionally pre-drying to remove moisture before frying;
i) Frying in the oil;
j) Cooling.

In a preferred aspect the present invention pertains to a process for the production of a legume based instant fried noodle comprising 10 to 60 wt % of chickpea flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition), 1 to 20 wt % of starch (by weight of the total composition) and 10 to 25 wt % of oil (by weight of the total composition), the process comprising the steps of:
a) Roasting chickpea splits;
b) Milling the roasted chickpea splits to obtain roasted chickpea flour;
c) Mixing the roasted chickpea flour, wheat flour, starch, wheat gluten and optionally other dry ingredients with the Kansui salts and water to form a dough;
d) Sheeting and slitting the dough to obtain noodle strands;
e) Steaming the noodle strands from step d);
f) Optionally seasoning;
g) Cutting and folding the noodle strands from steps e) or f);
h) Optionally pre-drying to remove moisture before frying;
i) Frying in the oil;
j) Cooling.

In a preferred aspect the present invention pertains to a process for the production of a legume based instant fried noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition), 2 to 15 wt % of starch (by weight of the total composition) and 10 to 20 wt % of oil (by weight of the total composition), the process comprising the steps of:
a) Roasting legume splits selected from the group of chickpea splits, lentil splits, or a combination thereof and milling the roasted legume splits to obtain roasted legume flour or roasting legume flour selected from the group of chickpea flour, lentil flour, or a combination thereof to obtain roasted legume flour;
b) Mixing the roasted legume flour, cereal flour, starch, wheat gluten and optionally other dry ingredients with the Kansui salts and water to form a dough;
c) Sheeting and slitting the dough to obtain noodle strands;
d) Steaming the noodle strands from step c);
e) Optionally seasoning;
f) Cutting and folding the noodle strands from steps d) or e);
g) Optionally pre-drying to remove moisture before frying;
h) Frying in the oil;
i) Cooling.

In a preferred aspect the present invention pertains to a process for the production of a legume based instant fried noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition), 2 to 15 wt % of starch (by weight of the total composition) and 10 to 20 wt % of oil (by weight of the total composition), the process comprising the steps of:
a) Roasting legume splits selected from the group of chickpea splits, lentil splits, or a combination thereof;
b) Milling the roasted legume splits to obtain roasted legume flour;
c) Mixing the roasted legume flour, cereal flour, starch, wheat gluten and optionally other dry ingredients with the Kansui salts and water to form a dough;
d) Sheeting and slitting the dough to obtain noodle strands;
e) Steaming the noodle strands from step d);
f) Optionally seasoning;
g) Cutting and folding the noodle strands from steps e) or f);
h) Optionally pre-drying to remove moisture before frying;
i) Frying in the oil;
j) Cooling.

In a preferred aspect the present invention pertains to a process for the production of a legume based instant fried noodle comprising 27 to 50 wt % of chickpea flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition), 2 to 15 wt % of starch (by weight of the total composition) and to 20 wt % of oil (by weight of the total composition), the process comprising the steps of:
a) Roasting chickpea splits at a temperature between 100 to 160° C. for 2 to 8 hours;
b) Milling the roasted chickpea splits to obtain roasted chickpea flour;
c) Mixing the roasted chickpea flour, wheat flour, starch, wheat gluten and optionally other dry ingredients with the Kansui salts and water to form a dough;
d) Sheeting and slitting the dough to obtain noodle strands;
e) Steaming the noodle strands from step d);
f) Optionally seasoning;
g) Cutting and folding the noodle strands from steps e) or f);
h) Optionally pre-drying to remove moisture before frying;
i) Frying in the oil;
j) Cooling.

In a second aspect the invention relates to a legume based dried instant noodle comprising legume flour, cereal flour, starch, Kansui salts and wheat gluten, wherein the legume based dried instant noodle has an amount of protein of at least 10 wt % (by weight of the total composition) and wherein the legume flour is selected from the group of chickpea flour, lentil flour, or combinations thereof, preferably roasted chickpea flour, roasted lentil flour, or combinations thereof.

In a preferred aspect the invention relates to a legume based dried instant noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition) and 1 to 20 wt % of starch (by weight of the total composition), wherein the legume based dried instant noodle has an amount of protein of at least 10 wt % (by weight of the total composition) and wherein the legume flour is selected from the group of chickpea flour, lentil flour, or combinations thereof, preferably roasted chickpea flour, roasted lentil flour, or combinations thereof.

In a preferred aspect the invention relates to a legume based dried instant noodle comprising 10 to 60 wt % of chickpea flour (by weight of the total composition), preferably roasted chickpea flour, 5 to 70 wt % of wheat flour (by weight of the total composition), 0.2 to 3.5 wt % of Kansui salts (by weight of the total composition), 0.5 to 10 wt % of wheat gluten (by weight of the total composition) and 1 to 20 wt % of starch (by weight of the total composition), wherein the legume based dried instant noodle has an amount of protein of at least 10 wt % (by weight of the total composition).

In a preferred aspect the invention relates to a legume based dried instant noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition) and 2 to 15 wt % of starch (by weight of the total composition), wherein the legume based dried instant noodle has an amount of protein of at least 10 wt % (by weight of the total composition) and wherein the legume flour is selected from the group of chickpea flour, lentil flour, or combinations thereof, preferably roasted chickpea flour, roasted lentil flour, or combinations thereof.

In a preferred aspect the invention relates to a legume based dried instant noodle comprising 27 to 50 wt % of chickpea flour (by weight of the total composition), preferably roasted chickpea flour, 15 to 45 wt % of wheat flour (by weight of the total composition), 0.2 to 3.5 wt % of Kansui salts (by weight of the total composition), 2 to 10 wt % of wheat gluten (by weight of the total composition) and 2 to 15 wt % of starch (by weight of the total composition), wherein the legume based dried instant noodle has an amount of protein of at least 10 wt % (by weight of the total composition).

In a preferred aspect the invention relates to a legume based instant fried noodle comprising 10 to 60 wt % of legume flour (by weight of the total composition), 5 to 70 wt % of cereal flour (by weight of the total composition), 0.2 to 3.5 wt % of Kansui salts (by weight of the total composition), 0.5 to 10 wt % of wheat gluten (by weight of the total composition), 1 to 20 wt % of starch (by weight of the total composition) and 10 to 25 wt % of oil (by weight of the total composition), wherein the legume based instant fried noodle has an amount of protein of at least 10 wt % (by weight of the total composition) and wherein the legume flour is selected from the group of chickpea flour, lentil flour, or combinations thereof, preferably roasted chickpea flour, roasted lentil flour, or combinations thereof.

In a preferred aspect the invention relates to a legume based instant fried noodle comprising 10 to 60 wt % of chickpea flour (by weight of the total composition), preferably roasted chickpea flour, 5 to 70 wt % of wheat flour (by weight of the total composition), 0.2 to 3.5 wt % of Kansui salts (by weight of the total composition), 0.5 to 10 wt % of wheat gluten (by weight of the total composition), 1 to 20 wt % of starch (by weight of the total composition) and to 25 wt % of oil (by weight of the total composition), wherein the legume based instant fried noodle has an amount of protein of at least 10 wt % (by weight of the total composition).

In a preferred aspect the invention relates to a legume based instant fried noodle comprising 27 to 50 wt % of legume flour (by weight of the total composition), 15 to 45 wt % of cereal flour (by weight of the total composition), 0.2 to 3.5 wt % of Kansui salts (by weight of the total composition), 2 to 10 wt % of wheat gluten (by weight of the total composition), 2 to 15 wt % of starch (by weight of the total composition) and 10 to 20 wt % of oil (by weight of the total composition), wherein the legume based instant fried noodle has an amount of protein of at least 10 wt % (by weight of the total composition) and wherein the legume flour is selected from the group of chickpea flour, lentil flour, or combinations thereof, preferably roasted chickpea flour, roasted lentil flour, or combinations thereof.

In a preferred aspect the invention relates to a legume based instant fried noodle comprising 27 to 50 wt % of chickpea flour (by weight of the total composition), preferably roasted chickpea flour, 15 to 45 wt % of wheat flour (by weight of the total composition), 0.2 to 3.5 wt % of Kansui salts (by weight of the total composition), 2 to 10 wt % of wheat gluten (by weight of the total composition), 2 to 15 wt % of starch (by weight of the total composition) and 10 to 25 wt % of oil (by weight of the total composition), wherein the legume based instant fried noodle has an amount of protein of at least 10 wt % (by weight of the total composition).

The term “legume splits” are skinned legume selected from the group of chickpea splits, lentil splits, or a combination thereof, preferably chickpea, split into two halves. The average particle shape is between 2 to 10 mm long, 2 to 8 mm wide. In an embodiment the legume splits does not include soybean splits.

The term “legume flour” according to this invention is selected from the group of chickpea flour, lentil flour or combinations thereof, preferably chickpea flour. In an embodiment the legume based dried instant noodle does not comprise soybean flour. In an embodiment the legume based dried instant noodle comprises 10 to 60 wt % of legume flour (by weight of the total composition) selected from the group of chickpea flour, lentil flour or combinations thereof, preferable 10 to 55 wt %, preferable 10 to 50 wt %, preferably 20 to 60 wt %, preferably 20 to 55 wt %, preferably 20 to 50 wt %, preferably 25 to 60 wt %, preferably 25 to 55 wt %, preferably 25 to 50 wt %, preferably 27 to 60 wt %, preferably 27 to 55 wt %, preferably 27 to 50 wt %, preferably 27 to 45 wt %, preferably 30 to 60 wt %, preferably 30 to 55 wt %, preferably 30 to 50 wt %, preferably 30 to 45 wt % (by weight of the total composition). In an embodiment the legume based dried instant noodle comprises 10 to 60 wt % of chickpea flour (by weight of the total composition), preferable 10 to 55 wt %, preferable 10 to 50 wt %, preferably 20 to 60 wt %, preferably 20 to 55 wt %, preferably 20 to 50 wt %, preferably 25 to 60 wt %, preferably 25 to 55 wt %, preferably 25 to 50 wt %, preferably 27 to 60 wt %, preferably 27 to 55 wt %, preferably 27 to 50 wt %, preferably 27 to 45 wt %, preferably 30 to 60 wt %, preferably 30 to 55 wt %, preferably 30 to 50 wt %, preferably 30 to 45 wt % (by weight of the total composition). In an embodiment the lentil flour is green lentil flour, red lentil flour, or a combination thereof.

The roasting is done between a temperature range of 80-160° C. for 2 to 8 hours, preferably between a temperature range of 90 to 160° C. for 2 to 8 hours, preferably between a temperature range of 100 to 160° C. for 2 to 8 hours, preferably between a temperature range of 110 to 160° C. for 2 to 7 hours, preferably between a temperature range of 120 to 150° C. for 2 to 6 hours, preferably between a temperature range of 130 to 150° C. for 2 to 6 hours. The term “roasted legume flour” according to this invention means a type of flour that has been roasted before being ground into a fine powder. The roasting process enhances the flavor and aroma of the legume. In an embodiment the roasted legume flour is selected from the group of roasted chickpea flour, roasted lentil flour, or combinations thereof. The term “roasted chickpea flour” according to this invention is a type of flour that has been roasted before being ground into a fine powder. The roasting process enhances the flavor and aroma of the chickpea.

The term “cereal flour” according to this invention means at least one ingredient of wheat flour, oat flour, corn flour, rice flour, barley flour, millet flour or combinations thereof, preferably wheat flour. In an embodiment the cereal flour is standard refined wheat flour. In an embodiment the legume based dried instant noodle comprises 5 to 70 wt % of cereal flour (by weight of the total composition), preferable 10 to 70 wt %, preferably 5 to 65 wt %, preferably 10 to 65 wt %, preferably 15 to 65 wt %, preferably 15 to 60 wt %, preferably 15 to 55 wt %, preferably 15 to 50 wt %, preferably 15 to 45 wt %, preferably 15 to 40 wt %, preferably 20 to 60 wt %, preferably 20 to 55 wt %, preferably 20 to 50 wt %, preferably 20 to 45 wt %, preferably 20 to 40 wt % (by weight of the total composition). In an embodiment the legume based dried instant noodle comprises 5 to 70 wt % of wheat flour (by weight of the total composition), preferable 10 to 70 wt %, preferably 5 to 65 wt %, preferably 10 to 65 wt %, preferably 15 to 65 wt %, preferably 15 to 60 wt %, preferably 15 to 55 wt %, preferably 15 to 50 wt %, preferably 15 to 45 wt %, preferably 15 to 40 wt %, preferably 20 to 60 wt %, preferably 20 to 55 wt %, preferably 20 to 50 wt %, preferably 20 to 45 wt %, preferably 20 to 40 wt % (by weight of the total composition).

In an embodiment the legume flour or the cereal flour or combination thereof has a particle size of 50 to 400 μm. A finer particle size could mean a high chance of starch to be damaged in the flour leading to higher water absorption. The dough would become sticky and causes operation issues. In addition, the noodle would turns sticky, starchy and non-elastic. A flour with a large particle size, on the other hand, needs longer water absorption time and often forms large dough lumps.

In an embodiment a legume based dried instant noodle comprising an amount of protein of at least 10 wt % (by weight of the total composition), preferably at least 11 wt %, preferably at least 12 wt %, preferably between 10 to 17 wt %, preferably between 11 to 17 wt %, preferably between 10 to 16 wt %, preferably between 11 to 16 wt %, preferably between 12 to 17 wt %, preferably between 12 to 16 wt % (by weight of the total composition).

In an embodiment the legume based dried instant noodle comprises 0.5 to 15 wt % of wheat gluten (by weight of the total composition), preferable 1 to 15 wt %, preferable 2 to 15 wt %, preferable 3 to 15 wt %, preferable 1 to 10 wt %, preferably 2 to 10 wt %, preferably 2 to 8 wt %, preferable 3 to 10 wt % (by weight of the total composition).

“Starch” according to this invention has two main polysaccharides amylose and amylopectin. Starches granules can be isolated from a wide variety of plant sources, consisting of tuberous root, tuber and seeds. Based on the botanical origin, starch granules come in different shapes, sizes and have varying ratios of amylose/amylopectin. Starch according to this invention is a native starch, pre-gelatinized starch or cold swelling starch or combination thereof, preferably a native starch. The starch according to the invention is selected from the group consisting of maize, waxy maize, high amylose maize, wheat, tapioca, rice, potato, cassava or combinations of these. In an embodiment the legume based dried instant noodle comprises 1 to 20 wt % of starch (by weight of the total composition), preferable 2 to 20 wt %, preferably 1 to 15 wt %, preferably 2 to 15 wt, preferable 1 to 10 wt %, preferable 2 to 10 wt % (by weight of the total composition).

In a preferred embodiment the instant fired noodle has a ratio between starch and wheat gluten between 1.25 to 3.5.

The term “kansui salts” comprises a mixture of alkaline salts comprising sodium chloride, sodium carbonate, potassium carbonate or sodium phosphate or a combination thereof. In an embodiment the legume based dried instant noodle comprises 0.2 to 3.5 wt % of kansui salts (by weight of the total composition). In a preferred embodiment the kansui salts are dissolved in water to obtain a kansui solution. The term “kansui solution” comprises a mixture of 1 to 15 wt % of alkaline salts comprising sodium chloride, sodium carbonate, potassium carbonate or sodium phosphate or a combination thereof (based on the total amount of the solution) in 85 to 99 wt % of water (based on the total amount of the solution), preferably the kansui solution comprises 3 to 7 wt % of alkaline salts and 93 to 97 wt % of water (based on the total amount of the solution).

The term “oil” according to this invention is selected from the group of palm oil, sunflower oil, high oleic oils, high oleic sunflower oil (HOSO), ground nut oil, rice bran oil, mustard oil, soybean oil or a combination thereof, preferably palm oil or high oleic sunflower oil or combination thereof.

The dough mixing time is between 10 to 40 minutes, preferably 15 to 30 minutes. A twin speed mixer is used. The mixing speed is between 50 to 120 rpm. High speed mixing (between 100 to 120 rpm) is recommended during the time the kansui solution is dosed to avoid localized dosing and to ensure homogeneity. For addition of small ingredients like calcium carbonate, fortificant (vitamin and/or mineral) it is recommended to make a pre-blend with flour before addition. The amount of water added has a big influence on dough formation. The moisture content of the dough after mixing should be between 20 to 40%, preferably between 25 to 35%. If too much water is added the dough will be too soft and sticky. If too less water is added the noodle will be brittle, doughy and hard-centered due to insufficient gelatinisation during steaming as degree of gelatinisation depends on moisture content of dough.

The term “sheeting” is a process step wherein the dough is passed through a series of rollers to obtain a final sheet of desired thickness which will then determine the noodle strand thickness. By sheeting the dough a network is developed as pressure is applied. In addition, the sheeting removes entrapped air from the dough and therefore reduces porosity and result in less oil uptake.

The slitter/cutter called “kiriha” consists of a pair of grooved cylinders which cut and separate the dough sheet into strands that are trapped in the grooves. These strands are immediately removed by a comb-like scraper, called “kasuri” which is attached in between the two rollers. The width of the noodle strand is determined by Kiriha groove width.

The purpose of steaming is to gelatinize the starch in order to eliminate the raw and doughy taste on the end-product. Steaming time and temperature along with steam pressure affect product quality and are known to the person skilled in the art. Good steaming results to obtain at least 80% starch gelatinisation is giving a better association of starch granules and protein matrix as well as better continuity of protein network. The steaming time is between 0.5 to 15 minutes, preferably 0.5 to 7 minutes. A saturated steam is used. If steaming is insufficient, the final noodle will have a gritty center, doughy and raw wheat after taste (cereal note). Noodle strands coming out of the steamer are hot and tend to stick to the steamer mesh conveyor. This can lead to poor cutting and folding down the line. Therefore, the strands are cooled and slightly dried up using fans or blowers/air knives at the exit of steamer tunnel.

Seasoning means that flavor or flavors are added by a spraying or within a seasoning bath.

Cutting and folding occur after steaming the noodle strands. Cutting means that the noodle strands are cut to a desired length and folded. At this stage, the noodle is still quite flexible but is able retain its shape.

Pre-drying is used to reduce the wet cake moisture content by 2 to 10%. In addition after pre-drying an oil up take reduction by 1 to 8%, preferably 2 to 4% is achieved. A pre-drying step is done at a temperature between 50 to 120° C. within 15 to 500 sec, preferably at a temperature between 60 to 100° C. within 30 to 400 sec. In a preferred embodiment the noodles are pre-dried.

Frying is a process wherein moisture from cakes is removed to a desired level and doughy taste is eliminated in the end product. Steamed or pre-dried noodle cakes are conveyed to the fryer buckets which pass through the hot oil bath. The Frying in oil is done at temperatures between 110 to 170° C. and a frying time between 30 to 200 seconds, preferably at temperatures between 130 to 165° C. and a frying time between 40 to 150 seconds. After oil frying the final moisture in the product is less than 10 wt %, preferably between 2 to 10 wt % (by weight of the total composition). The final product has a water activity <0.6.

In an embodiment the legume based dried instant noodle has an amount of oil in the range of 10 to 30 wt % (by weight of the total composition), preferably between 12 to 28 wt %, preferably between 13 to 25 wt %, preferably between 13 to 19 wt % (by weight of the total composition).

Cooling means that the temperature of the noodle after frying in the oil is reduced. It is desirable to have the noodle cake temperature the same as or close to room temperature before wrapping, preferably between 20 to 30° C., more preferably between 20 to 25° C. Otherwise, there may be condensation of water vapour in the packet of noodles, which may lead to mould growth. A side from condensates, hot cakes also cause expansion of air within the pack, subsequently causing difficulty in secondary packaging.

Those skilled in the art will understand that they can freely combine all features of the present invention disclosed herein. In particular, features described for different embodiments of the present invention may be combined. Where known equivalents exist to specific features, such equivalents are incorporated as if specifically referred to in this specification.

### EXAMPLES

### Example 1: Process

Legume slits are roasted using a drum dryer at a temperature at 130° C. for 4 hours. After roasting the legume splits are milled to obtain a roasted legume flour. Standard dried instant noodle manufacturing process involves mixing of roasted legume flour, cereal flour (wheat flour), starch, wheat gluten and kansui solution in a batch mixer. Noodle line used for the production is from CCK supplier. Dough from mixer is passed through rollers to form two sheets thereafter compounding the two dough sheets into one, reducing dough sheet to a desired thickness through a series of rollers. The final sheet is passed through the kiriha to slit the dough sheet and form the noodle strands, which are then steamed in a tunnel.

The steamed noodles are cut, folded and moulded into pre-dryer. The pre-dryer removes moisture before frying and helps to reduce the oil uptake. The pre-dried noodle cakes are discharged from pre-dryer to frying bucket, which are then passed through a fryer where noodle cakes are fried, and moisture is removed. After which, the cakes are cooled to ambient temperature before packing. This process describes a fried noddle. A skilled person can easily adapt the process to obtain an air-dried noodle cake. For example an air dried noodle cake has some oil in the noodle dough but has no step of pre-drying and oil frying. Below table shows details of all the process steps with the process parameters:

| Process Steps | Process Parameters | Moisture |
|---|---|---|
| Mixing | High Speed: 90 Hz, 1 min Dry Mixing | 30-31% |
| | High Speed: 90 Hz, 4 min Kansui Dosing | |
| | Low Speed: 50 Hz, 16 minute for | |
| | gluten development | |
| Sheeting & | Final Sheet Thickness: 0.9 mm, Kiriha | |
| Slitting | K 30 | |
| Steaming | Time: 130 s, Saturated Steam | 31-32% |
| Cut and Fold | Bag type | |
| Predrying | Temp: 80° C., Time: 225 s | 25-27% |
| Frying | Temp: 150° C., Time: 70 s, Oil Uptake: | 2-6% |
| | 14-16% | |
| Cooling | Ambient temperature and Packaging | 2-6% |

### Examples 2-13

Examples 4, 6 and 8 to 13 are prepared according to example 1. Comparison examples 2, 3, 5 and 7 use raw chickpea flour which was not roasted. Example 12 use instead of roasted Besan (chickpea) roasted yellow lentil flour. Example 13 is a baked noodle having some oil content in the noodle dough but are not fried.

| | | | |
|---|---|---|---|
| Comp. | Comp. | | Com. |
| Ex 2 | Ex 3 | Ex. 4 | Ex. 5 |

Noddle dough composition

| | | | | |
|---|---|---|---|---|
| Wheat flour | 65 | 59 | 59 | 51 |
| Besan roasted | 0 | 0 | 12 | 0 |
| Besan raw without | 12 | 12 | | 23 |
| roasting | | | | |
| Kansui | 23 | 23 | 23 | 23 |
| Starch | 0 | 4 | 4 | 0 |
| Wheat gluten | 0 | 2 | 2 | 3 |
| Oil used for | Palm oil | Palm oil | Palm oil | Palm oil |
| oil frying | | | | |

Process & Product features

| | | | | |
|---|---|---|---|---|
| Machinability | 1 | 3 | 3 | 2 |
| Cooked noodle | 1 | 2 | 3 | 2 |
| texture | | | | |
| Cooked noodle flavor | 1 | 1 | 4 | 1 |
| Overall acceptance | 1 | 2 | 3 | 1.75 |
| Comments | Sticky | Acceptable | Acceptable | Sticky |
| | dough; | sheeting; | sheeting, | dough, |
| | very | slightly firm | no raw | very poor |
| | poor | texture; raw | taste, | sheeting; |
| | sheeting | taste and | improved | raw taste |
| | | lower water | water | and lower |
| | | absorption in | absorption | water |
| | | cooked | as comp. | absorption |
| | | noodles | ex. 2 | |

| | | | |
|---|---|---|---|
| | Comp. | | |
| Ex. 6 | Ex 7 | Ex. 8 | Ex. 9 |

Noddle dough composition

| | | | | |
|---|---|---|---|---|
| Wheat flour | 44 | 21 | 21 | 33 |
| Besan roasted | 23 | 0 | 40 | 31 |
| Besan raw without roasting | 0 | 40 | 0 | 0 |
| Kansui | 23 | 21 | 21 | 22 |
| Starch | 7 | 12 | 12 | 9 |
| Wheat gluten | 3 | 6 | 6 | 5 |
| Oil used for | Palm oil | Palm oil | Palm oil | HOSO |
| oil frying | | | | |

Process & Product features

| | | | | |
|---|---|---|---|---|
| Machinability | 4 | 3 | 5 | 4 |
| Cooked noodle texture | 4 | 1 | 5 | 3 |
| Cooked noodle flavor | 4 | 1 | 5 | 4 |
| Overall acceptance | 4 | 1.5 | 5 | 4 |
| Comments | Acceptable | Acceptable | Optimum | Acceptable |
| | sheeting; | sheeting; | sheeting; | sheeting; |
| | no raw taste; | firm and | good | Slightly |
| | improved | bouncy | texture; no | firm; |
| | water | texture; | raw taste; | no raw |
| | absorption | raw taste; | good water | taste; |
| | as comp. | poor water | absorption | |
| | ex. 5 | absorption | | |

| | | | |
|---|---|---|---|
| Ex. 10 | Ex. 11 | Ex. 12 | Ex. 13 |

Noddle dough composition

| | | | | |
|---|---|---|---|---|
| Wheat flour | 35 | 11 | 35 | 21 |
| Besan roasted | 32 | 48 | 0 | 40 |
| Yellow lentils | 0 | 0 | 32 | 0 |
| roasted | | | | |
| Besan raw without roasting | 0 | 0 | 0 | 0 |
| Kansui | 21 | 20 | 21 | 21 |
| Starch | 8 | 14 | 8 | 12 |
| Wheat gluten | 5 | 6 | 5 | 6 |
| | | | | — |
| Oil used for oil | Palm oil | Palm oil | Palm oil | Palm oil |
| frying | | | | |

Process & Product features

| | | | | |
|---|---|---|---|---|
| Machinability | 5 | 3 | 5 | 5 |
| Cooked noodle texture | 5 | 4 | 5 | 4 |
| Cooked noodle flavor | 5 | 4 | 4 | 4 |
| Overall acceptance | 5 | 3.7 | 4.5 | 4 |
| Comments | Optimum | Acceptable | Optimum | Optimum |
| | sheeting; | sheeting; | sheeting; | sheeting; |
| | good texture; | slightly | good | good |
| | no raw taste; | firm texture; | texture; no | texture; no |
| | good water | no raw taste; | raw taste; | raw taste; |
| | absorption | | good water | good water |
| | | | absorption | absorption |

Comparison examples 2 and 5 have not used starch and wheat gluten in the noodle dough composition, which resulted in a sticky dough and very poor sheeting. Comparison examples 3 and 7 use starch and wheat gluten, which resulted in acceptable sheeting. Nevertheless comparison examples 3 and 7 have a raw taste of Besan (chickpea) and poor water absorption of the cooked instant noodles. Example 8 use roasted Besan flour but otherwise the same composition as comparison example 7, which resulted in an optimal sheeting, good texture, no raw taste and good water absorption. As shown within examples 4, 6 and 8 to 13 it is essential to use roasted legume flour, starch and wheat gluten to substitute cereal flour.

1. A process for the production of a legume based dried instant noodle comprising legume flour, cereal flour, Kansui salts, starch and wheat gluten, the process comprising the steps of:
a) Roasting legume splits selected from the group consisting of chickpea splits, lentil splits, and a combination thereof and milling the roasted legume splits to obtain roasted legume flour, or roasting legume flour selected from the group consisting of chickpea flour, lentil flour, and a combination thereof to obtain roasted legume flour;
b) Mixing the roasted legume flour, the cereal flour, the starch, the wheat gluten and optionally other dry ingredients with the Kansui salts and water to form a dough;
c) Sheeting and slitting the dough to obtain noodle strands;
d) Steaming the noodle strands from step c);
e) Cutting the steamed noodle strands from step d) and optionally folding;
f) Frying the cut noodle strands from step e) in oil, or air drying the cut noodle strands from step e); and
g) Cooling the fried noodle strands.

2. The process according to claim 1, wherein the legume based dried instant noodle comprises 10 to 60 wt % of the legume flour (by weight of the total composition), 5 to 70 wt % of the cereal flour (by weight of the total composition), 0.2 to 3.5 wt % of the Kansui salts (by weight of the total composition), 0.5 to 10 wt % of the wheat gluten (by weight of the total composition), and 1 to 20 wt % of the starch (by weight of the total composition).

3. The process according to claim 1, wherein the legume based dried instant noodle has a ratio between the starch and the wheat gluten between 1.25 to 3.5.

4. The process according to claim 1, wherein the legume splits are chickpea splits or wherein the legume flour is chickpea flour.

5. The process according to claim 1, wherein the cereal flour is wheat flour, oat flour, corn flour, rice flour, barley flour, millet flour or combinations thereof.

6. The process according to claim 1, wherein the kansui salts comprise sodium chloride, sodium carbonate, potassium carbonate, sodium phosphate or a combination thereof.

7. The process according to claim 1, wherein the kansui salts are added as a solution of 1 to 10 wt % of sodium chloride, sodium carbonate, potassium carbonate and sodium phosphate (based on the total amount of the solution) in 90 to 99 wt % of the water (based on the total amount of the solution).

8. The process according to claim 1, wherein the roasting is done between a temperature range of 80-160° C. for 2 to 8 hours.

9. The process according to claim 1, wherein the instant noodle is fried in the oil at a temperature between 110 to 170° C. and a frying time between 30 to 200 seconds.

10. The process according to claim 1, wherein the steaming comprises using saturated steam within 0.5 to 15 min.

11. The process according to claim 1, wherein pre-drying is done at a temperature between 50 to 120° C. and 15 to 500 sec.

12. A legume based dried instant noodle comprising 10 to 60 wt % of legume flour (by weight of the total composition) selected from the group consisting of chickpea flour, lentil flour, and a combination thereof, 5 to 70 wt % of cereal flour (by weight of the total composition), 0.2 to 3.5 wt % of Kansui salts (by weight of the total composition), 0.5 to 10 wt % of wheat gluten (by weight of the total composition), and 1 to 20 wt % of starch (by weight of the total composition), wherein the legume based dried instant noodle has an amount of protein of at least 10 wt % (by weight of the total composition).

13. The legume based dried instant noodle as claimed in claim 12, wherein the legume flour is a roasted legume flour selected from the group consisting of roasted chickpea flour, roasted lentil flour, and a combination thereof,

14. A method of preparing a food product, the method comprising wrapping a legume based dried instant noodle in a packet, the legume based dried instant noodle comprising 10 to 60 wt % of legume flour (by weight of the total composition) selected from the group consisting of chickpea flour, lentil flour, and a combination thereof, 5 to 70 wt % of cereal flour (by weight of the total composition), 0.2 to 3.5 wt % of Kansui salts (by weight of the total composition), 0.5 to 10 wt % of wheat gluten (by weight of the total composition), and 1 to 20 wt % of starch (by weight of the total composition), wherein the legume based dried instant noodle has an amount of protein of at least 10 wt % (by weight of the total composition).

15. The process according to claim 1, wherein the cereal flour is wheat flour.
